(19) United States
(12) Patent Application Publication
(10) Pub. No.: US 2013/0081281 A1
(43) Pub. Date: Apr. 4, 2013

(54) RETRACTABLE KNIFE WITH A SAFETY LOCK

(71) Applicant: Jitung Chu, New Taipei City (TW)

(72) Inventor: Jitung Chu, New Taipei City (TW)

(21) Appl. No.: 13/252,603

(22) Filed: Oct. 4, 2011

(51) Int. Cl. B26B 1/08

(52) U.S. Cl. 30/162

(57) ABSTRACT

A retractable knife has a handle, an operating element, a blade assembly and a safety lock. The handle has a casing and a cover. The casing has a guiding channel and two sliding recesses. The cover is connected securely to the casing and has a guiding slot and two button-holes. The operating element is slidably mounted in the handle and has a guiding shaft and a pushing button. The blade assembly is connected to the handle and the operating element and has a blade and a mounting panel. The mounting panel is connected to the blade, is securely mounted in the handle and has a column slot and two pairs of positioning holes. The safety lock is slidably mounted on the handle between the cover and the mounting panel, is selectively locked with the operating element and has a front locking lever and a rear locking lever.

### BACKGROUND OF THE INVENTION

1. Field of the Invention

The present inventions relates to a retractable knife, and more particularly to a retractable knife with a safety lock that can enable a blade of the retractable knife to straightly extend out and retract into the retractable knife and can be locked safely in use.

2. Description of Related Art

A conventional retractable knife has a handle, an operational button, a blade and a spring. The handle is hollow and has an open front end, a closed rear end, a top face, a chamber and a guiding slot. The chamber is formed in the handle between the open front end, the closed rear end and the top face. The guiding slot is formed through the top face of the handle between the open front end and the closed rear end of the handle. The operating button is slidably mounted in guiding slot of the handle, is held by the handle and has an inner end and an outer end. The inner end of the operating button is mounted in the chamber of the handle. The outer end of the operating button extends out of the guiding slot of the handle. The blade is mounted in the chamber of the handle, is connected to the operating button and has a connecting end and an extending end. The connecting end of the blade is connected to the inner end of the operating button. The extending end of the blade selectively extends out of the open front end of the handle. The spring is mounted in the chamber of the handle and is compressed and abuts between the closed rear end of the handle and the connecting end of the blade.

When a user wants to use the conventional retractable knife, the operating button is disengaged from the handle, the spring will push the blade to move forward to enable the extending end of the blade to extend out of the open front end of the handle and the operating button will move forward along the guiding slot. Although the blade can be extended out of the open front end of the handle by the spring, the blade cannot be held at a desired position relative to the handle and this will affect the operation of the conventional retractable knife. In addition, the operating button cannot be held securely and this will enable the blade to extend out of the handle when the operating button is accidentally touched and pushed by an external force. Then, the extending blade may injure people and this is unsafe in use.

To overcome the shortcomings, the present invention provides a retractable knife to mitigate or obviate the aforementioned problems.

### SUMMARY OF THE INVENTION

The main objective of the present invention is to provide a retractable knife with a safety lock that can enable a blade of the retractable knife to straightly extend out and retract into the retractable knife and can be locked safely in use.

The retractable knife in accordance with the present invention has a handle, an operating element, a blade assembly and a safety lock. The handle has a casing and a cover. The casing has a guiding channel and two sliding recesses. The cover is connected securely to the casing and has a guiding slot and two button-holes. The operating element is slidably mounted in the handle and has a guiding shaft and a pushing button. The blade assembly is connected to the handle and the operating element and has a blade and a mounting panel. The blade is slidably mounted in the casing, is securely connected to the guiding shaft and has a through hole, two mounting protrusions, two springs, two guiding columns and two mounting posts. The mounting panel is connected to the blade, is securely mounted in the handle and has a column slot and two pairs of positioning holes. The safety lock is slidably mounted on the handle between the cover and the mounting panel, is selectively locked with the operating element and has a front locking lever and a rear locking lever. Each locking lever has a locking hole and a locking button.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a retractable knife in accordance with the present invention;

FIG. 2 is another perspective view of a retractable knife in accordance with the present invention when a blade extends out of the retractable knife;

FIG. 3 is an exploded perspective view of the retractable knife in FIG. 2;

FIG. 4 is another exploded perspective view of the retractable knife in FIG. 2;

FIG. 5 is a further exploded perspective view of the retractable knife in FIG. 2;

FIG. 6 is a cross-sectional end view of the retractable knife in FIG. 1;

FIG. 7 is another cross-sectional end view of the retractable knife in FIG. 1;

FIG. 8 is a side view in partial section of the retractable knife in FIG. 2;

FIG. 9 is an operational side view in partial section of the retractable knife in FIG. 8;

FIG. 10 is a side view in partial section of the retractable knife in FIG. 1;

FIG. 11 is a top view in partial section of the retractable knife in FIG. 2; and

FIG. 12 is an operational top view in partial section of the retractable knife in FIG. 2.

### DETAILED DESCRIPTION OF THE PREFERRED EMBODIMENT

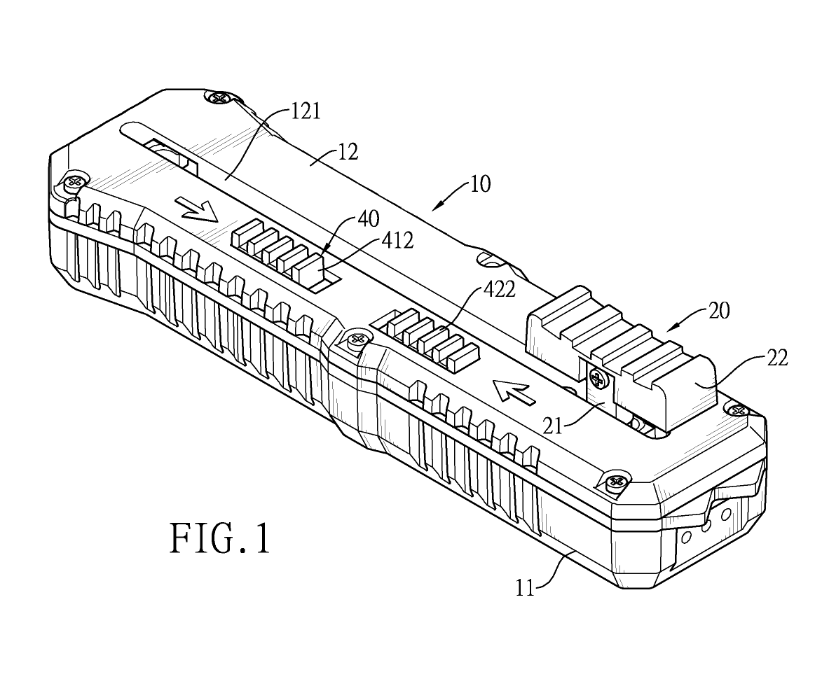

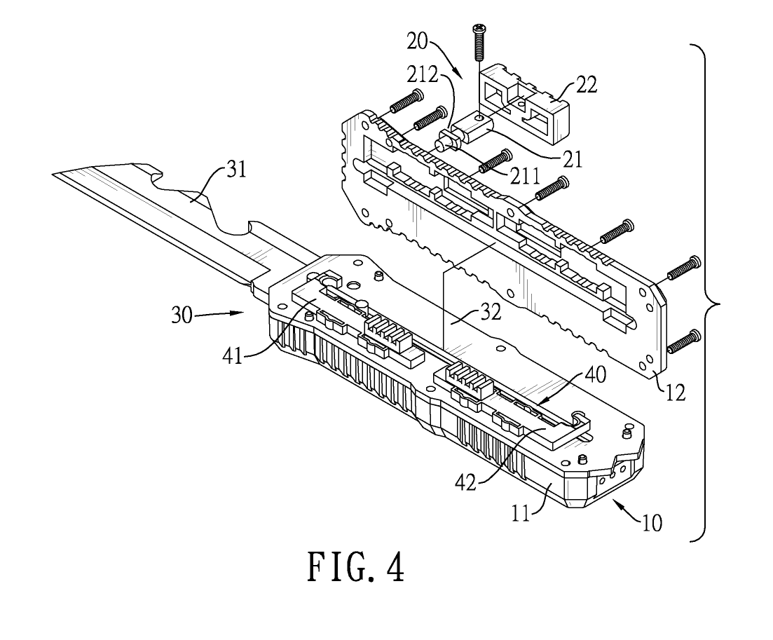

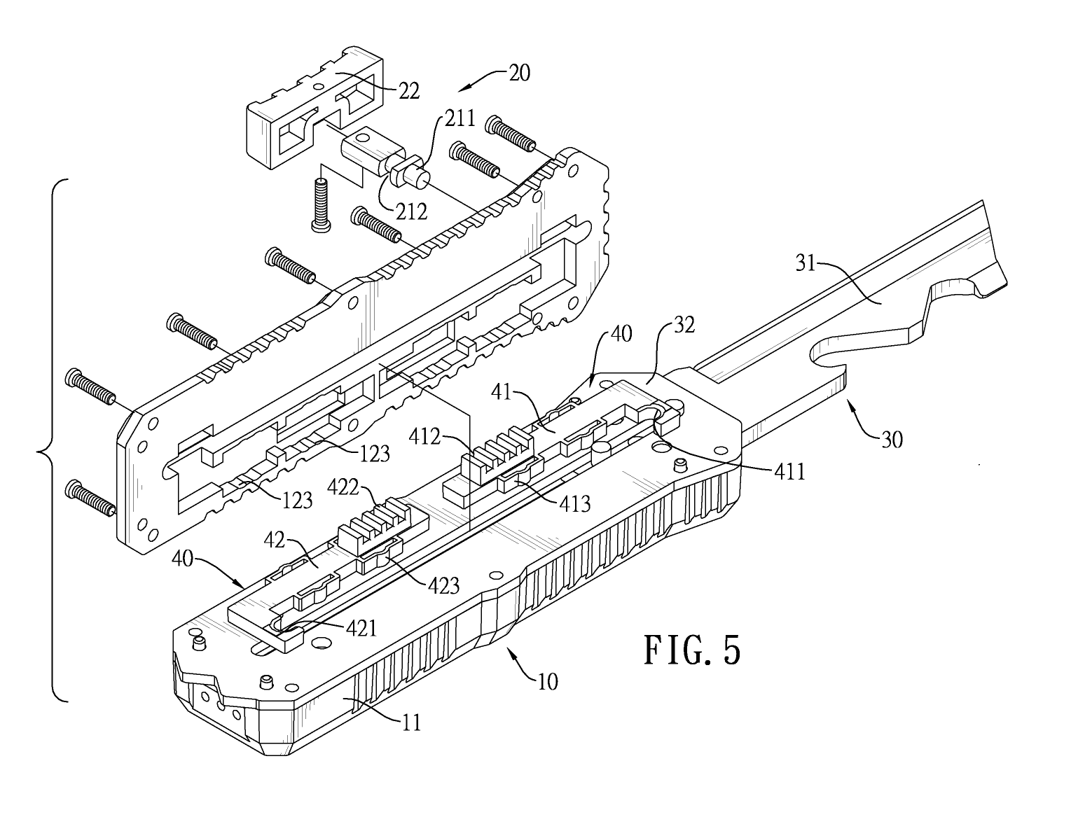

With reference to FIGS. 1 to 5, a retractable knife in accordance with the present invention has a handle 10, an operating element 20, a blade assembly 30 and a safety lock 40.

The handle 10 has a casing 11 and a cover 12.

The casing 11 is hollow and has an open front end, a closed rear end, a bottom face, a top face, a guiding channel 111 and two sliding recesses 112. The guiding channel 111 is formed in the bottom face of the casing 11 between the open front end and the closed rear end of the casing 11. The sliding recesses 112 are formed in the bottom face of the casing 11 between the open front end and the closed rear end of the casing 11 beside the guiding channel 111.

The cover 12 is connected securely to the casing 11 by fasteners, is mounted on the top face of the casing 11 and has a top face, a bottom face, a front end, a rear end, a guiding slot 121, two button-holes 122 and multiple pairs of limiting recesses 123. The guiding slot 121 is formed through the top face and the bottom face of the cover 12 between the ends of the cover 12 and communicates with the guiding channel 111 of the casing 11. The button-holes 122 are formed through the top face and the bottom face of the cover 12 and align with each other beside the guiding slot 121 above one of the sliding recesses 112. Each pair of limiting recesses 123 is formed in the bottom face of the cover 12.

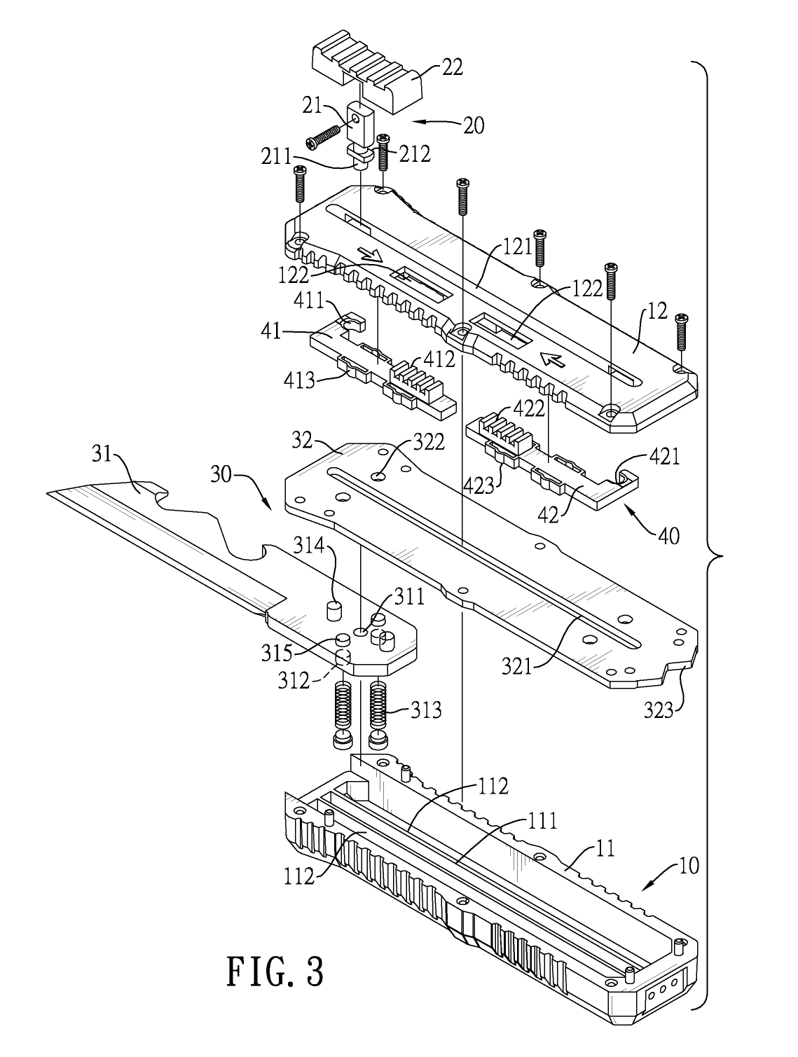

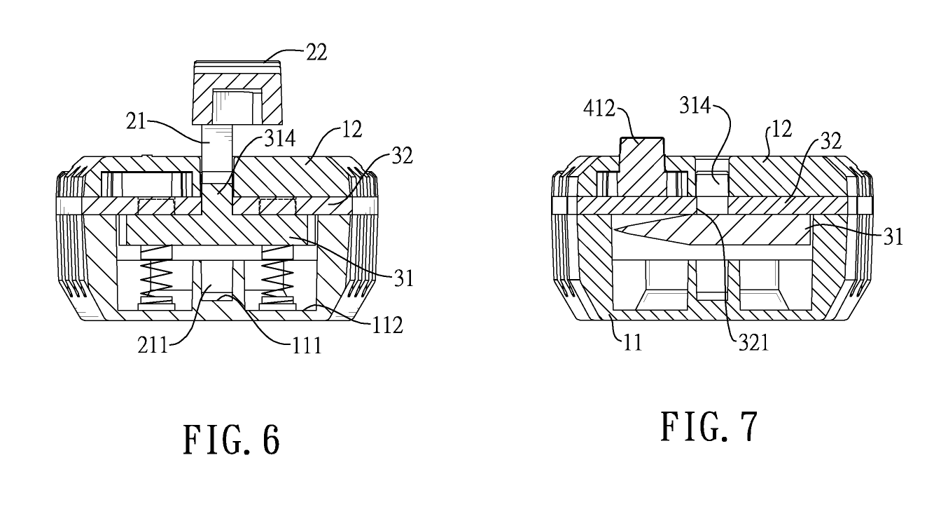

With reference to FIGS. 3, 5 and 6, the operating element 20 is slidably mounted on the handle 10 and has a guiding shaft 21 and a pushing button 22.

The guiding shaft 21 is mounted in the guiding channel 111 of the casing 11 via the guiding slot 121 of the cover 12 and has a lower end, an upper end, an external surface, a mounting rod 211 and a locking recess 212. The upper end of the guiding shaft 21 extends out of the cover 12 via the guiding slot 121. The mounting rod 211 is formed on the lower end of the guiding shaft 21 and extends in the guiding channel 111 of the casing 11. The locking recess 212 is formed annularly around the external surface of the guiding shaft 21 near the mounting rod 211 at a position between the guiding channel 111 of the casing 11 and the guiding slot 121 of the cover 12. The pushing button 22 is connected securely to the upper end of the guiding shaft 21 above the guiding slot 121 of the cover 12 to enable the guiding shaft 21 to move along the guiding channel 111 of the casing 11 and the guiding slot 121 of the cover 12 relative to the handle 10.

The blade assembly 30 is connected to the handle 10 and the operating element 20 and has a blade 31 and a mounting panel 32.

The blade 31 is slidably mounted in the casing 11 of the handle 10 above the guiding channel 111 and the sliding recesses 112, is securely connected to the guiding shaft 21 of the operating element 20 and has a connecting end, an extending end, a top face, a bottom face, a through hole 311, two mounting protrusions 312, two springs 313, two guiding columns 314 and two mounting posts 315. The connecting end of the blade 31 is slidably mounted in the handle 10 between the casing 11 and the cover 12. The extending end of the blade 31 selectively extends out of the open front end of the casing 11. The through hole 311 is formed through the top face and the bottom face of the blade 31 and is mounted around the mounting rod 211 of the guiding shaft 21 to enable the lower end of the guiding shaft 21 to extend in the guiding channel 111 of the casing 11.

The mounting protrusions 312 are formed on and protrude from the bottom face of the blade 31 beside the through hole 311 and respectively face the sliding recesses 112 of the casing 11. The springs 313 are respectively mounted around the mounting protrusions 312 and are respectively and slidably mounted in the sliding recesses 112 of the casing 11. The guiding columns 314 are formed on and protrude from the top face of the blade 31 beside the through hole 311 and extend in the guiding slot 121 of the cover 12. The mounting posts 315 are formed on and protrude from the top face of the blade 31 between the guiding columns 314.

The mounting panel 32 is connected to the blade 31, is securely mounted in the handle 10 between the casing 11 and the cover 12 and has a front end, a rear end, a column slot 321, two pairs of positioning holes 322 and a glass-breaking edge 323. The column slot 321 is formed through the mounting panel 32 and communicates with the guiding channel 111 of the casing 11 and the guiding slot 121 of the cover 12 to enable the guiding columns 314 to extend in the guiding slot 121 of the cover 12. The two pairs of positioning holes 322 are respectively formed through the mounting panel 32 at the front end and the rear end of the mounting panel 32 and are selectively mounted around the mounting posts 315 of the blade 31. The glass-breaking edge 323 is formed on and protrudes from the rear end of the mounting panel 32 and extends out of the handle 10 between the cover 12 and the casing 11.

With reference to FIGS. 3, 5 and 7, the safety lock 40 is slidably mounted on the handle 10 between the cover 12 and the mounting panel 32, is selectively locked with the operating element 20 and has a front locking lever 41 and a rear locking lever 42.

The front locking lever 41 may be L-shaped, is slidably mounted between the mounting panel 32 and the cover 12 near the open front end of the casing 11 and has a locking end, a pushing end, two sidewalls, a locking hole 411, a locking button 412 and multiple limiting protrusions 413. The locking end of the front locking lever 41 extends to the front ends of the cover 12 and the mounting panel 32 between the guiding slot 121 and the column slot 321. The pushing end of the front locking lever 41 extends below one of the button-holes 122.

The locking hole 411 may be semicircular, is formed through the locking end of the front locking lever 41 and communicates with the the guiding slot 121 of the cover 12 and the column slot 321 of the mounting panel 32 to selectively lock the guiding shaft 21 of the operating element 20 by the locking recess 212. The locking button 412 is formed on and protrudes from the pushing end of the front locking lever 41 and extends out of the cover 12 via the corresponding button-hole 122. The limiting protrusions 413 are formed on and protrude from the sidewalls of the front locking lever 41, and each limiting protrusion 413 selectively engages one of a corresponding pair of limiting recesses 123 of the cover 12.

The rear locking lever 42 may be L-shaped, is slidably mounted between the mounting panel 32 and the cover 12 near the closed rear end of the casing 11 and has a locking end, a pushing end, two sidewalls, a locking hole 421, a locking button 422 and multiple limiting protrusions 423. The locking end of the rear locking lever 42 extends to the rear ends of the cover 12 and the mounting panel 32 between the guiding slot 121 and the column slot 321. The pushing end of the rear locking lever 42 extends below the other button-hole 122 of the cover 12. The locking hole 421 may be semicircular, is formed through the locking end of the rear locking lever 42 and communicates with the the guiding slot 121 of the cover 12 and the column slot 321 of the mounting panel 32 to selectively lock the guiding shaft 21 of the operating element 20 by the locking recess 212.

The locking button 422 is formed on and protrudes from the pushing end of the rear locking lever 42 and extends out of the cover 12 via the corresponding button-hole 122. The limiting protrusions 423 are formed on and protrude from the sidewalls of the rear locking lever 42, and each limiting protrusion 423 selectively engages one of a corresponding pair of limiting recesses 123 of the cover 12.

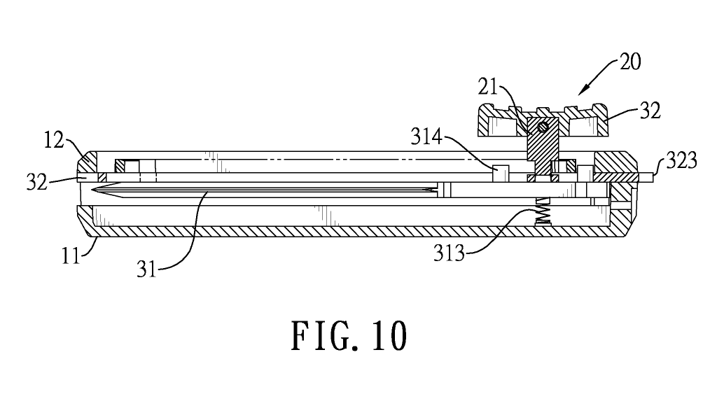

With reference to FIGS. 1 and 10, when the blade 31 of the retractable knife in accordance with the present invention is retracted in the handle 10 between the casing 11 and the cover 12, the operating element 20 is moved with the blade 31 to the rear end of the cover 12 and the springs 313 will push the guiding shaft 21 to move upwardly to enable the locking recess 212 to align with the locking hole 421 of the rear locking lever 42. The rear locking lever 42 can be moved forward relative to the handle 10 by pushing the locking button 422 to enable the locking hole 421 of the rear locking lever 42 to move in and engage securely the locking recess 212 of the guiding shaft 21. Then, the guiding shaft 21 is securely held by the rear locking lever 42 and the operating element 20 cannot be pressed downwardly relative to the handle 10 to separate from the rear locking lever 42 and this can prevent the blade 31 from moving out of the handle 10 when the pushing button 22 is accidentally touched and pushed by an external force.

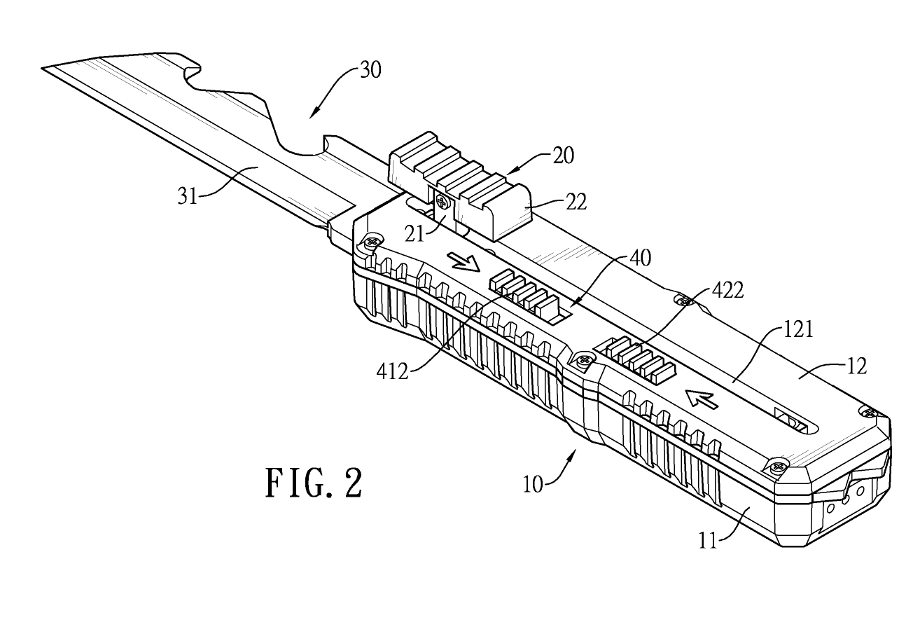

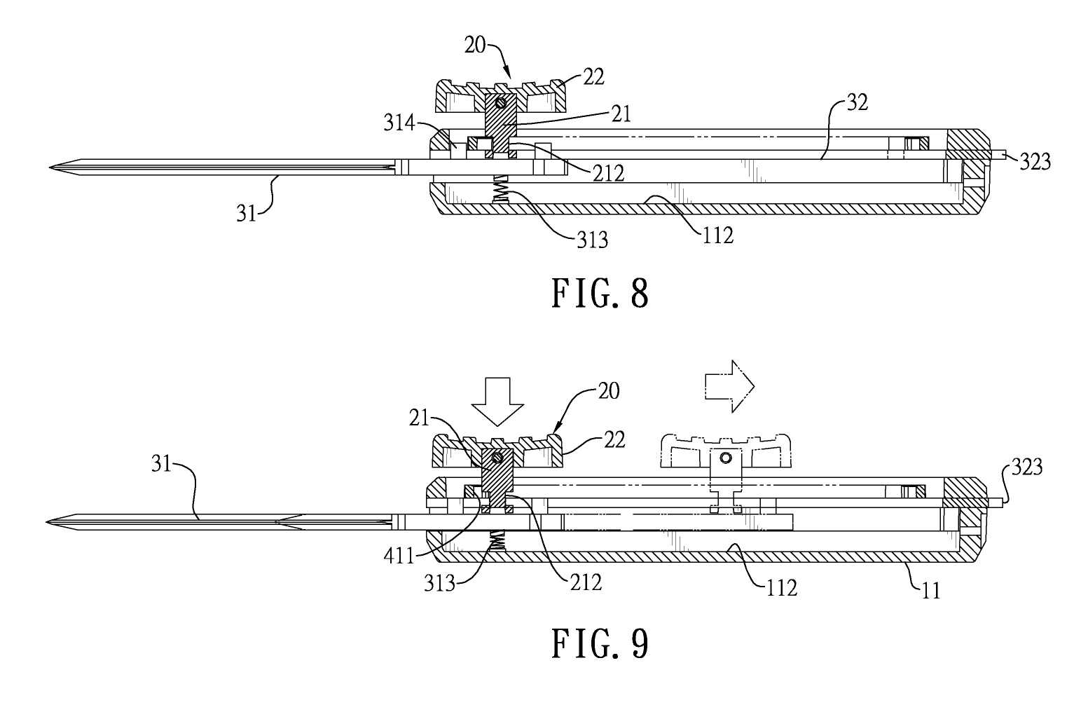

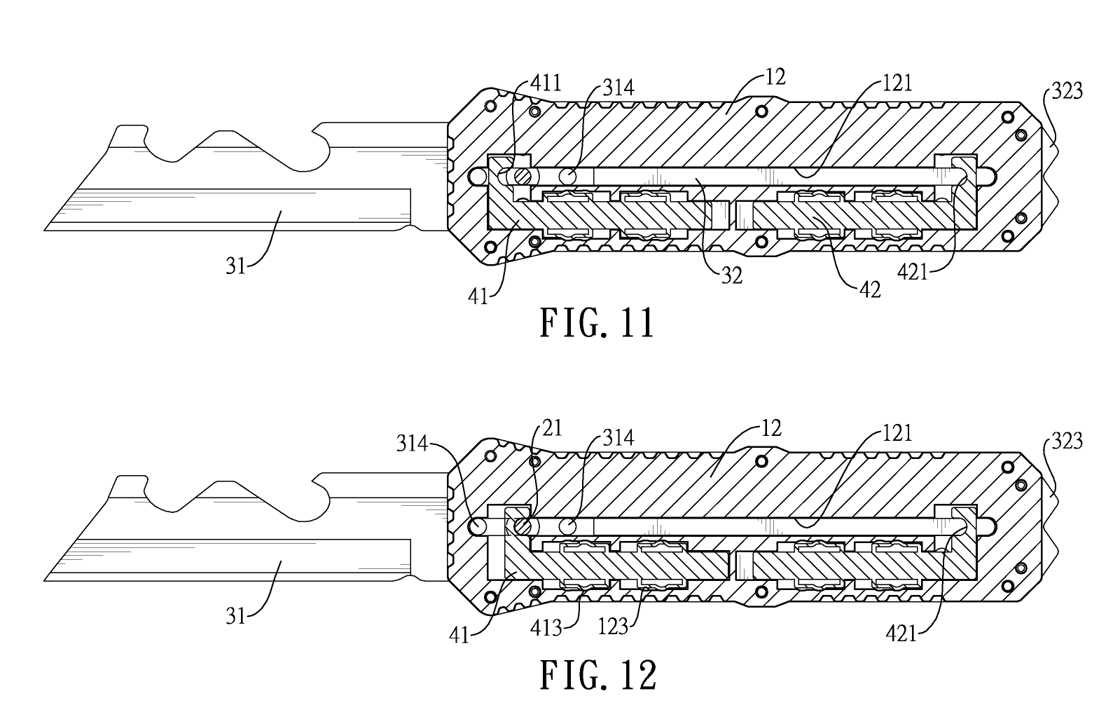

When the blade 31 of the retractable knife in accordance with the present invention is needed to extend out of the handle 10, the rear locking lever 42 is moved backwardly to the original position to enable the locking recess 212 of the guiding shaft 21 to disengage from the locking hole 421 of the rear locking lever 42. Then, with reference to FIGS. 2, 8 and 11, the operating element 20 can be pressed downwardly and pushed forwardly relative to the handle 10 along the guiding slot 121 of the cover 12 and this can enable the blade 31 to move forward and extend out of the open front end of the casing 11 along the column slot 321 of the mounting panel 32 as shown in FIG. 2.

When the blade 31 is extended out of the casing 11 of the handle 10 by the operating element 20, the pushing button 22 of the operating element 20 is released from an external force and the springs 313 will push the guiding shaft 21 to move upwardly to enable the locking recess 212 to align with the locking hole 411 of the front locking lever 41. With reference to FIG. 12, the front locking lever 41 can be moved backward relative to the handle 10 by pushing the locking button 412 to enable the locking hole 411 of the front locking lever 41 to move in and engage securely the locking recess 212 of the guiding shaft 21. Then, the guiding shaft 21 is securely held by the front locking lever 41 and the operating element 20 cannot be pressed downwardly relative to the handle 10 to separate from the front locking lever 41 and this can prevent the blade 31 from moving relative to the handle 10 and this will not affect the operation of the retractable knife in use.

With reference to FIG. 9, after using the retractable knife in accordance with the present invention, the front locking lever 41 is moved forwardly to the original position to enable the locking recess 212 of the guiding shaft 21 to disengage from the locking hole 411 of the front locking lever 41. Then, the operating element 20 can be pressed downwardly and pushed backwardly relative to the handle 10 along the guiding slot 121 of the cover 12 and this can enable the blade 31 to move backward and move into the casing 11 along the column slot 321 of the mounting panel 32 as shown in FIG. 1 and the blade 31 is held securely and safely in the handle 10 by the rear locking lever 42 as above-mentioned.

Furthermore, the engagement between the limiting recesses 123 of the cover 12 and the limiting protrusions 413, 423 can provide a preferred limiting effect to the locking levers 41, 42 to hold the operating element 20 securely with the front locking lever 41 or the rear locking lever 42 of the safety lock 40. In addition, when the blade 31 moves relative to the handle 10, the mounting posts 315 are selectively mounted in the positioning holes 322 at the front end or the rear end of the mounting panel 32 and this can provide a positioning effect to the blade 31. Additionally, the glass-breaking edge 323 that is formed on and protrudes from the rear end of the mounting panel 32 and extends out of the handle 10 between the cover 12 and the casing 11 can be used to break glass.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A retractable knife having
a handle having
a casing being hollow and having
an open front end;
a closed rear end;
a bottom face;
a top face;
a guiding channel formed in the bottom face of the casing between the open front end and the closed rear end of the casing; and
two sliding recesses formed in the bottom face of the casing between the open front end and the closed rear end of the casing beside the guiding channel; and
a cover connected securely to the casing, mounted on the top face of the casing and having
a top face;
a bottom face;
a front end;
a rear end;
a guiding slot formed through the top face and the bottom face of the cover between the ends of the cover and communicating with the guiding channel of the casing; and
two button-holes formed through the top face and the bottom face of the cover and aligning with each other beside the guiding slot above one of the sliding recesses;
an operating element slidably mounted on the handle and having
a guiding shaft mounted in the guiding channel of the casing via the guiding slot of the cover and having
a lower end mounted in the guiding channel of the casing;
an upper end extending out of the cover via the guiding slot;
an external surface;
a mounting rod formed on the lower end of the guiding shaft and extending in the guiding channel of the casing; and
a locking recess formed annularly around the external surface of the guiding shaft near the mounting rod at a position between the guiding channel of the casing and the guiding slot of the cover; and
a pushing button connected securely to the upper end of the guiding shaft above the guiding slot of the cover to enable the guiding shaft to move along the guiding channel of the casing and the guiding slot of the cover relative to the handle;
a blade assembly connected to the handle and the operating element and having
a blade slidably mounted in the casing of the handle above the guiding channel and the sliding recesses, securely connected to the guiding shaft of the operating element and having
a connecting end slidably mounted in the handle between the casing and the cover;
an extending end selectively extending out of the open front end of the casing;
a top face;
a bottom face;
a through hole formed through the top face and the bottom face of the blade and mounted around the mounting rod of the guiding shaft to enable the lower end of the guiding shaft to extend in the guiding channel of the casing;
two mounting protrusions formed on and protruding from the bottom face of the blade beside the through hole and respectively facing the sliding recesses of the casing;
two springs respectively mounted around the mounting protrusions and respectively and slidably mounted in the sliding recesses of the casing;
two guiding columns formed on and protruding from the top face of the blade beside the through hole and extending in the guiding slot of the cover; and
two mounting posts formed on and protruding from the top face of the blade between the guiding columns; and
a mounting panel connected to the blade, securely mounted in the handle between the casing and the cover and having
a front end;
a rear end;
a column slot formed through the mounting panel and communicating with the guiding channel of the casing and the guiding slot of the cover to enable the guiding columns to extend in the guiding slot of the cover; and
two pairs of positioning holes respectively formed through the mounting panel at the front end and the rear end of the mounting panel and selectively mounted around the mounting posts of the blade; and
a safety lock slidably mounted on the handle between the cover and the mounting panel, selectively locked with the operating element and having
a front locking lever slidably mounted between the mounting panel and the cover near the open front end of the casing and having
a locking end extending to the front ends of the cover and the mounting panel between the guiding slot and the column slot;
a pushing end extending below one of the button-holes of the cover;
a locking hole formed through the locking end of the front locking lever and communicating with the the guiding slot of the cover and the column slot of the mounting panel to selectively lock the guiding shaft of the operating element by the locking recess; and
a locking button formed on and protruding from the pushing end of the front locking lever and extending out of the cover via the corresponding button-hole; and
a rear locking lever slidably mounted between the mounting panel and the cover near the closed rear end of the casing and having
a locking end extending to the rear ends of the cover and the mounting panel between the guiding slot and the column slot;
a pushing end extending below the other button-hole of the cover;
a locking hole formed through the locking end of the rear locking lever and communicating with the guiding slot of the cover and the column slot of the mounting panel to selectively lock the guiding shaft of the operating element by the locking recess; and
a locking button formed on and protruding from the pushing end of the rear locking lever and extending out of the cover via the corresponding button-hole.

2. The retractable knife as claimed in claim 1, wherein the mounting panel has a glass-breaking edge formed on and protruding from the rear end of the mounting panel and extending out of the handle between the cover and the casing.

3. The retractable knife as claimed in claim 2, wherein
the cover has multiple pairs of limiting recesses and each pair of limiting recesses is formed in the bottom face of the cover;
the front locking lever has
two sidewalls; and
multiple limiting protrusions formed on and protruding from the sidewalls of the front locking lever and each limiting protrusion selectively engaging one of a corresponding pair of limiting recesses of the cover; and
the rear locking lever has
two sidewalls; and
multiple limiting protrusions formed on and protruding from the sidewalls of the rear locking lever and each limiting protrusion selectively engaging one of a corresponding pair of limiting recesses of the cover.

4. The retractable knife as claimed in claim 3, wherein
the front locking lever is L-shaped;
the locking hole of the front locking lever is semicircular;
the rear locking lever is L-shaped; and
the locking hole of the rear locking lever is semicircular.

5. The retractable knife as claimed in claim 1, wherein
the cover has multiple pairs of limiting recesses and each pair of limiting recesses is formed in the bottom face of the cover;
the front locking lever has
two sidewalls; and
multiple limiting protrusions formed on and protruding from the sidewalls of the front locking lever and each limiting protrusion selectively engaging the limiting recesses of a corresponding pair of limiting recesses of the cover; and
the rear locking lever has
two sidewalls; and
multiple limiting protrusions formed on and protruding from the sidewalls of the rear locking lever and each limiting protrusion selectively engaging the limiting recesses of a corresponding pair of limiting recesses of the cover.

6. The retractable knife as claimed in claim 1, wherein
the front locking lever is L-shaped;
the locking hole of the front locking lever is semicircular;
the rear locking lever is L-shaped; and
the locking hole of the rear locking lever is semicircular.
